(19) United States
(12) Patent Application Publication
(10) Pub. No.: US 2019/0218340 A1
(43) Pub. Date: Jul. 18, 2019

(54) BATTERY CASE, BATTERY, LIQUID CRYSTAL POLYMER, AND ARTICLE

(71) Applicant: SAMSUNG ELECTRONICS CO., LTD., Suwon-si (KR)

(72) Inventors: Joungeun YOO, Seongnam-si (KR); In Ki KIM, Hwaseong-si (KR); Kyeong PANG, Suwon-si (KR); In KIM, Suwon-si (KR); Feifei FANG, Suwon-si (KR); In Su LEE, Hwaseong-si (KR); Hyoungwoo CHOI, Hwaseong-si (KR)

(21) Appl. No.: 16/249,305

(22) Filed: Jan. 16, 2019

(30) Foreign Application Priority Data
Jan. 16, 2018 (KR) 10-2018-0005743

(51) Int. Cl. C08G 69/44; H01M 2/02; H01M 2/04; H01M 2/30; H01M 10/0525

(52) U.S. Cl. CPC C08G 69/44; H01M 2/0257; H01M 2/0478; B29C 45/0001; H01M 10/0525; C08G 2250/00; H01M 2/30

(57) ABSTRACT

A battery case comprising a container configured to house an electrode assembly, wherein the container includes a bottom wall and a plurality of side walls, the bottom wall and the plurality of side walls are integrated to define an internal space for housing the electrode assembly and to further define a top opening on an opposing side from the bottom wall, at least one of the bottom wall and the plurality of side walls comprises a liquid crystal aromatic poly(ester amide), and the battery case has a water vapor transmission rate (WVTR) at a wall thickness of 1 millimeter of less than or equal to about 0.07 grams per square meter per day, as measured at 38° C. and a relative humidity of 100% according to ISO 15106 or ASTM F1249.

### CROSS-REFERENCE TO RELATED APPLICATION

This application claims priority to and the benefit of Korean Patent Application No. 10-2018-0005743 filed in the Korean Intellectual Property Office on Jan. 16, 2018, and all the benefits accruing therefrom under 35 U.S.C. § 119, the entire content of which is incorporated herein by reference.

### BACKGROUND

### 1. Field

This disclosure relates to a battery case, a battery, a liquid crystal polymer for forming the battery case, and an article including the liquid crystal polymer.

### 2. Description of the Related Art

Mobile electronic devices and means of electric transportation both require a power source (e.g., a battery) for supplying them with electricity (or motive power). The battery may be housed in a battery case, and the unit then disposed individually or as a module including one or more units in these devices or means of transportation. Accordingly, further development of technology capable of improving properties of the battery case is needed.

### SUMMARY

An embodiment provides a battery case having improved moisture transmission resistivity and impact strength.

Another embodiment provides a battery including the battery case.

Yet another embodiment provides a liquid crystal polymer having improved moisture transmission resistivity and impact strength.

Still another embodiment provides an article of the liquid crystal polymer having improved moisture transmission resistivity and impact strength.

In an embodiment, a battery case includes a container configured to house an electrode assembly, wherein the container includes a bottom wall and a plurality of side walls, the bottom wall and the plurality side walls are integrated to define an internal space therein for housing the electrode assembly and to further define a top opening on an opposing side from the bottom wall, at least one of the bottom wall and the plurality of side walls includes a liquid crystal aromatic poly(ester amide), and the battery case has a water vapor transmission rate (WVTR) at a wall thickness of 1 millimeter (mm) of less than or equal to about 0.07 grams per square meter per day (g/m²/day), as measured at 38° C. and a relative humidity of 100% according to ISO 15106 or ASTM F1249.

The liquid crystal aromatic poly(ester amide) may be prepared by copolymerization (i.e., is a copolymerization product) of liquid crystal monomers including at least one of an aromatic aminocarboxylic acid represented by Chemical Formula 1 and an aromatic aminophenol represented by Chemical Formula 2, and an aromatic hydroxycarboxylic acid represented by Chemical Formula 3:

NH₂—Ar¹—COOH Chemical Formula 1

wherein, in Chemical Formula 1, Ar¹ is a substituted or unsubstituted arylene-containing group, which is a single substituted or unsubstituted C6 to C30 arylene group, a fused ring of two or more substituted or unsubstituted C6 to C30 arylene groups, or two or more substituted or unsubstituted C6 to C30 arylene groups linked by a single bond, —O—, —S—, —SO₂—, —C(═O)—, —CH₂ₙ—, —C(CₙH₂ₙ₊₁)— wherein n ranges from 1 to 10, —NR— wherein R is hydrogen or a C1 to C5 alkyl group, or a combination thereof;

NH₂—Ar²—OH Chemical Formula 2

wherein, in Chemical Formula 2, Ar² is a substituted or unsubstituted arylene group-group, which is a single substituted or unsubstituted C6 to C30 arylene group, a fused ring of two or more substituted or unsubstituted C6 to C30 arylene groups, or two or more substituted or unsubstituted C6 to C30 arylene groups linked by a single bond, —O—, —S—, —SO₂—, —C(═O)—, —CH₂ₙ—, —C(CₙH₂ₙ₊₁)— wherein n ranges from 1 to 10, or —NR— wherein R is hydrogen or a C1 to C5 alkyl group, or a combination thereof; and

OH—Ar³—COOH Chemical Formula 3

wherein, in Chemical Formula 3, Ar³ is a substituted or unsubstituted arylene group containing group, which is a single substituted or unsubstituted C6 to C30 arylene group, a fused ring of two or more substituted or unsubstituted C6 to C30 arylene groups, or two or more substituted or unsubstituted C6 to C30 arylene groups linked by a single bond, —O—, —S—, —SO₂—, —C(═O)—, —CH₂ₙ—, —C(CₙH₂ₙ₊₁)— wherein n ranges from 1 to 10, or —NR— wherein R is hydrogen or a C1 to C5 alkyl group, or a combination thereof.

The liquid crystal aromatic poly(ester amide) may be prepared by copolymerization (i.e., is the copolymerization product) of liquid crystal monomers including the aromatic aminocarboxylic acid represented by Chemical Formula 1 and the aromatic hydroxycarboxylic acid represented by Chemical Formula 3.

The aromatic aminocarboxylic acid represented by Chemical Formula 1 may include 4-aminobenzoic acid, and the aromatic hydroxycarboxylic acid represented by Chemical Formula 3 may include 4-hydroxybenzoic acid.

The aromatic hydroxycarboxylic acid represented by Chemical Formula 3 may further include at least one of glycolic acid, 6-hydroxy-2-naphthoic acid, 6-hydroxy-1-naphthoic acid, 3-methyl-4-hydroxybenzoic acid, 3,5-dimethyl-4-hydroxybenzoic acid, 2,6-dimethyl-4-hydroxybenzoic acid, 3-methoxy-4-hydroxybenzoic acid, 3,5-dimethoxy-4-hydroxybenzoic acid, 6-hydroxy-5-methyl-2-naphthoic acid, 6-hydroxy-5-methoxy-2-naphthoic acid, 2-chloro-4-hydroxybenzoic acid, 3-chloro-4-hydroxybenzoic acid, 2,3-dichloro-4-hydroxybenzoic acid, 3,5-dichloro-4-hydroxybenzoic acid, 2,5-dichloro-4-hydroxybenzoic acid, 3-bromo-4-hydroxybenzoic acid, 6-hydroxy-5-chloro-2-naphthoic acid, 6-hydroxy-7-chloro-2-naphthoic acid, 6-hydroxy-5,7-dichloro-2-naphthoic acid, p-β-hydroxyethoxybenzoic acid, or a combination thereof.

The aromatic hydroxycarboxylic acid represented by Chemical Formula 3 that is further included may be 6-hydroxy-2-naphthoic acid.

The liquid crystal monomers may further include at least one of an aromatic dicarboxylic acid represented by Chemical Formula 4 and an aromatic diol represented by Chemical Formula 5:

COOH—Ar⁴—COOH Chemical Formula 4

wherein, in Chemical Formula 4, Ar⁴ is a substituted or unsubstituted arylene-containing group, which is a single substituted or unsubstituted C6 to C30 arylene group, a fused ring of two or more substituted or unsubstituted C6 to C30 arylene groups, or two or more substituted or unsubstituted C6 to C30 arylene groups linked by a single bond, —O—, —S—, —SO₂—, —C(═O)—, —CH₂ₙ—, —C(CₙH₂ₙ₊₁)— wherein n ranges from 1 to 10, or —NR— wherein R is hydrogen or a C1 to C5 alkyl group, or a combination thereof; and

OH—Ar⁵—OH Chemical Formula 5

wherein, in Chemical Formula 5, Ar⁵ is a substituted or unsubstituted arylene group-group, which is a single substituted or unsubstituted C6 to C30 arylene group, a fused ring of two or more substituted or unsubstituted C6 to C30 arylene groups, or two or more substituted or unsubstituted C6 to C30 arylene groups linked by a single bond, —O—, —S—, —SO₂—, —C(═O)—, —CH₂ₙ—, —C(CₙH₂ₙ₊₁)— wherein n ranges from 1 to 10, or —NR— wherein R is hydrogen or a C1 to C5 alkyl group, or a combination thereof.

The aromatic dicarboxylic acid represented by Chemical Formula 4 may be at least one of terephthalic acid, 4,4′-biphenyldicarboxylic acid, 4,4′-terphenyldicarboxylic acid, 1,6-naphthalenedicarboxylic acid, 2,6-naphthalenedicarboxylic acid, 1,4-naphthalenedicarboxylic acid, 2,7-naphthalenedicarboxylic acid, diphenylether-4,4′-dicarboxylic acid, diphenoxyethane-4,4′-dicarboxylic acid, diphenoxybutane-4,4′-dicarboxylic acid, diphenylethane-4,4′-dicarboxylic acid, isophthalic acid, diphenylether-3,3′-dicarboxylic acid, diphenoxyethane-3,3′-dicarboxylic acid, diphenylethane-3,3′-dicarboxylic acid, chloroterephthalic acid, dichloroterephthalic acid, dichloroisophthalic acid, bromoterephthalic acid, methylterephthalic acid, dimethylterephthalic acid, ethylterephthalic acid, methoxyterephthalic acid, ethoxyterephthalic acid, or a combination thereof.

The aromatic diol represented by Chemical Formula 5 may be at least one of catechol, resorcinol, hydroquinone, 4,4′-dihydroxybiphenyl, 2,2-bis(4′-β-hydroxyethoxyphenyl)propane, bis(4-hydroxyphenyl)sulfone, bis(4-β-hydroxyethoxyphenyl) sulfonic acid, 9,9′-bis(4-hydroxyphenyl)fluorene, 3,3′-dihydroxybiphenyl, 4,4′-dihydroxyterphenyl, 2,6-naphthalenediol, 4,4′-dihydroxydiphenylether, bis(4-hydroxyphenoxy)ethane, 3,3′-dihydroxydiphenyl ether, 1,6-naphthalenediol, 2,2-bis(4-hydroxyphenyl)propane, bis(4-hydroxyphenyl)methane, chlorohydroquinone, methylhydroquinone, tert-butyl hydroquinone, phenylhydroquinone, methoxyhydroquinone, phenoxyhydroquinone, 4-chlororesorcinol, 4-methylresorcinol, or a combination thereof.

The liquid crystal aromatic poly(ester amide) may be prepared by copolymerization (i.e., is a copolymerization product) of liquid crystal monomers including the aromatic aminophenol represented by Chemical Formula 2 and the aromatic hydroxycarboxylic acid represented by Chemical Formula 3. The liquid crystal monomers including the aromatic aminophenol represented by Chemical Formula 2 and the aromatic hydroxycarboxylic acid represented by Chemical Formula 3 may further include the aromatic dicarboxylic acid represented by Chemical Formula 4.

At least one of the aromatic aminocarboxylic acid represented by Chemical Formula 1 and the aromatic aminophenol represented by Chemical Formula 2 may be included in an amount of less than or equal to about 20 mole percent (mol %), based on the total moles of the liquid crystal monomers for forming the liquid crystal aromatic poly(ester amide).

The aromatic hydroxycarboxylic acid represented by Chemical Formula 3 may include about 25 mol % to about 75 mol % of 4-hydroxybenzoic acid and about 75 mol % to about 25 mol % of an aromatic hydroxycarboxylic acid different from the 4-hydroxybenzoic acid, based on the total mole number of the aromatic hydroxycarboxylic acid.

The liquid crystal aromatic poly(ester amide) may be prepared by copolymerization (i.e., is a copolymerization product) of about 5 mol % to about 20 mol % of 4-aminobenzoic acid, about 5 mol % to about 70 mol % of 4-hydroxybenzoic acid, and about 25 mol % to about 80 mol % of 6-hydroxy-2-naphthoic acid.

The battery case may have an impact strength of greater than or equal to about 10 kilograms-force per square centimeters (kgf/cm²), as measured according to ASTM D265.

The battery case may further include a lid configured to cover at least a portion of the open side of the container, and at least one of a positive terminal and a negative terminal.

The lid may include the liquid crystal aromatic poly(ester amide).

A battery according to another embodiment includes the battery case according to one or more embodiment and an electrode assembly including a positive electrode and a negative electrode, wherein the electrode assembly is housed in the container of the battery case.

A liquid crystal polymer according to one or more embodiments may be a copolymer derived from about 5 mol % to about 20 mol % of 4-aminobenzoic acid, about 5 mol % to about 70 mol % of 4-hydroxybenzoic acid, and about 25 mol % to about 80 mol % of 6-hydroxy-2-naphthoic acid.

An article according to another embodiment may include the liquid crystal polymer according to an embodiment.

The battery case according to an embodiment includes an aromatic liquid crystal polymer including an ester bond and an amide bond, and thus barrier characteristics are improved, and simultaneously, impact strength is remarkably increased. Accordingly, the battery case according to an embodiment may be used for a rechargeable lithium battery requiring low aqueous vapor transmittance and the like and easily manufactured to have a desired size and shape in a publicly known method such as injection molding and the like. In addition, the battery case is light and strong against an impact, and thus may house a plurality of battery cells, and be used to manufacture a battery module capable of supplying large capacity of electricity and the like.

In another embodiment, a method for manufacturing a battery case including a liquid crystal aromatic poly(ester-amide) includes copolymerizing at least one of an aromatic aminocarboxylic acid and an aromatic aminophenol, and an aromatic hydroxycarboxylic acid to provide the liquid crystal aromatic poly(ester-amide), and molding the liquid crystal aromatic poly(ester-amide) to provide the battery case.

### BRIEF DESCRIPTION OF THE DRAWINGS

The above and/or other aspects of this disclosure will become more apparent by the following description of exemplary embodiments thereof, taken in conjunction with reference to the accompanying drawings.

FIG. 1 is an exploded perspective view showing a battery case according to an embodiment.

FIG. 2 is an exploded perspective view showing a battery case according to another embodiment.

### DETAILED DESCRIPTION

Advantages and characteristics of this disclosure, and a method for achieving the same, will become evident referring to the following example embodiments together with the drawings attached hereto. Hereinafter, embodiments of the present disclosure are described in further detail. However, these embodiments are exemplary, the present disclosure is not limited thereto, and the embodiments should not be construed as being limited to the exemplary embodiments set forth herein.

If not defined otherwise, all terms (including technical and scientific terms) in the specification may be defined as commonly understood by one skilled in the art. The terms defined in a generally-used dictionary may not be interpreted ideally or exaggeratedly unless clearly defined. In addition, unless explicitly described to the contrary, the word “comprise” and variations such as “comprises” or “comprising,” will be understood to imply the inclusion of stated elements but not the exclusion of any other elements.

Further, the singular includes the plural unless mentioned otherwise.

In the drawings, the thickness of each element is exaggerated for better comprehension and ease of description. Like reference numerals designate like elements throughout the specification. It will be understood that when an element such as a layer, film, region, or plate is referred to as being “on” another element, it can be directly on the other element or intervening elements may also be present. In contrast, when an element is referred to as being “directly on” another element, there are no intervening elements present.

Spatially relative terms, such as “beneath,” “under,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

It will be understood that, although the terms “first,” “second,” “third,” etc. may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, “a first element,” “component,” “region,” “layer,” or “section” discussed below could be termed a second element, component, region, layer, or section without departing from the teachings herein.

The terminology used herein is for the purpose of describing particular embodiments only and is not intended to be limiting. Reference throughout the specification to “an embodiment” means that a particular element described in connection with the embodiment is included in at least one embodiment described herein, and may or may not be present in other embodiments. The described elements may be combined in any suitable manner in the various embodiments. “Combination thereof” is an open term that includes one or more of the named elements, optionally together with a like element not named.

As used herein, the singular forms “a,” “an,” and “the” are intended to include the plural forms, including “at least one,” unless the content clearly indicates otherwise. “At least one” is not to be construed as limiting “a” or “an.” It will be further understood that the terms “comprises” and/or “comprising,” or “includes” and/or “including” when used in this specification, specify the presence of stated features, regions, integers, steps, operations, elements, and/or components, but do not preclude the presence or addition of one or more other features, regions, integers, steps, operations, elements, components, and/or groups thereof.

The endpoints of all ranges directed to the same component or property are inclusive and independently combinable (e.g., ranges of “less than or equal to 25 wt %, or 5 wt % to 20 wt %,” is inclusive of the endpoints and all intermediate values of the ranges of “5 wt % to 25 wt %,” etc.). Disclosure of a narrower range or more specific group in addition to a broader range is not a disclaimer of the broader range or larger group. “About” or “approximately” as used herein is inclusive of the stated value and means within an acceptable range of deviation for the particular value as determined by one of ordinary skill in the art, considering the measurement in question and the error associated with measurement of the particular quantity (i.e., the limitations of the measurement system). For example, “about” can mean within one or more standard deviations, or within +10%, or 5% of the stated value.

Unless otherwise defined, all terms (including technical and scientific terms) used herein have the same meaning as commonly understood by one of ordinary skill in the art to which this general inventive concept belongs. It will be further understood that terms, such as those defined in commonly used dictionaries, should be interpreted as having a meaning that is consistent with their meaning in the context of the relevant art and the present disclosure, and will not be interpreted in an idealized or overly formal sense unless expressly so defined herein.

Exemplary embodiments are described herein with reference to cross section illustrations that are schematic illustrations of idealized embodiments. As such, variations from the shapes of the illustrations as a result, for example, of manufacturing techniques and/or tolerances, are to be expected. Thus, embodiments described herein should not be construed as limited to the particular shapes of regions as illustrated herein but are to include deviations in shapes that result, for example, from manufacturing. For example, a region illustrated or described as flat may, typically, have rough and/or nonlinear features. Moreover, sharp angles that are illustrated may be rounded. Thus, the regions illustrated in the figures are schematic in nature and their shapes are not intended to illustrate the precise shape of a region and are not intended to limit the scope of the present claims. Like reference numerals designate like elements throughout the specification and drawings.

“Alkyl” means a straight or branched chain saturated aliphatic hydrocarbon having the specified number of carbon atoms. Examples of the alkyl group may be a methyl group, an ethyl group, an iso-propyl group, a tert-butyl group, or the like.

“Aryl” means a cyclic moiety in which all ring members are carbon and at least one ring is aromatic, the moiety having the specified number of carbon atoms. More than one ring may be present, and unless specified otherwise, any additional rings may be independently aromatic, saturated or partially unsaturated, and may be fused, pendant, spirocyclic, or a combination thereof.

“Arylene” means a divalent aryl group.

As used herein, when a definition is not otherwise provided, the term “substituted” refers to a group or compound wherein at least one of the hydrogen atoms thereof is substituted with a halogen atom (F, Cl, Br, or I), a hydroxy group, a nitro group, a cyano group, an amino group, an azido group, an amidino group, a hydrazino group, a hydrazono group, a carbonyl group, a carbamoyl group, a thiol group, an ester group, a carboxylic acid group or a salt thereof, a sulfonic acid group or a salt thereof, a phosphoric acid or a salt thereof, a C1 to C20 alkyl group, a C2 to C20 alkenyl group, a C2 to C20 alkynyl group, a C6 to C30 aryl group, a C7 to C30 arylalkyl group, a C1 to C30 alkoxy group, a C1 to C20 heteroalkyl group, a C3 to C20 heteroarylalkyl group, a C3 to C30 cycloalkyl group, a C3 to C15 cycloalkenyl group, a C6 to C15 cycloalkynyl group, a C3 to C30 heterocycloalkyl group, and a combination thereof.

When a group containing a specified number of carbon atoms is substituted with any of the groups listed in the preceding paragraph, the number of carbon atoms in the resulting “substituted” group is defined as the sum of the carbon atoms contained in the original (unsubstituted) group and the carbon atoms (if any) contained in the substituent. For example, when the term “substituted C1 to C20 alkyl” refers to a C1 to C20 alkyl group substituted with a C6 to C20 aryl group, the total number of carbon atoms in the resulting aryl substituted alkyl group is C7 to C40.

The symbol “*” in a Chemical Formula represents a point of attachment to another atom.

Recently, research on an electric vehicle (EV) using at least one battery system to supply a part or entire part of a motive power is actively being performed. The electric vehicle discharges fewer pollutants compared with a traditional vehicle operated by an internal combustion engine, and shows much higher fuel efficiency. Some electric vehicles using electricity use no gasoline at all, or obtain their entire motive power from electricity. As research on the electric vehicles is increased, there is a continuing need for an improved power source, such as, for example, an improved battery module.

A rechargeable lithium battery capable of being charged and discharged and having high energy density is considered as an electrochemical device of the battery module for these electric vehicles. However, as for the rechargeable lithium battery, when moisture is permeated through a battery exterior case, hydrofluoric acid (HF) may be generated inside the case and may cause performance degradation of an electrode. Accordingly, in order to prevent or reduce this performance degradation, an aluminum material having improved moisture transmission resistivity has been used as a case for a rechargeable lithium battery. In other words, an electrode assembly including positive and negative electrodes is inserted into a case such as an aluminum pouch and then together into an aluminum can, sealed to make a battery cell, and a plurality of the battery cells are then used to form a battery module. However, since this method requires a complicated assembly process and a high manufacture time, its productivity can be improved. Accordingly, a cell-module having an integrated structure, without forming a separate battery cell after forming the electrode assembly is being made, further improvements to mechanical strength, moisture transmission resistance, and the like, are desirable.

On the other hand, since a battery case formed of a conventional metal has a limited shape due to a limit in terms of a metal manufacture technology, a battery case having a desired shape and/or size requires a multistep process, a higher cost, and a high manufacture time. In addition, larger metal cases are heavy due to the weight of the metal and, when a plurality of containers is included in order to house a plurality of battery cells, the metal cases become even heavier and even more expensive. Accordingly, there is a continuing need for a material capable of solving the problems of heat management, moisture transmission, and the like, and having an increased impact strength, and that is appropriate for manufacturing an efficient battery case and a battery including the same with a lower cost.

The liquid crystal polymers are typically an aromatic polyester prepared from an aromatic monomer and is an engineering thermoplastic having high heat resistance. The liquid crystal polymer has a high melting point of about 300° C. or greater, and thus a melting process thereof is difficult. Accordingly, there have been many attempts to improve workability by lowering the melting point of the liquid crystal polymer. Alternatively, there have been attempts to increase mechanical properties of a polymer by copolymerizing a liquid crystal polymer with another polymer that is not a liquid crystal polymer, such as, for example, with PET (polyethylene terephthalate), PPT (polypropylene terephthalate), PTMT (polytrimethylene terephthalate), PEN (polyethylene naphthalate), and the like.

On the other hand, since packing density among polymer chains is important in order to increase barrier characteristics of a polymer, research on increasing an interaction among the polymer chains is being made, but this research on the liquid crystal polymer does not almost proceed ahead due to a limit of a monomer capable of forming the liquid crystal polymer. In addition, the liquid crystal polymer needs a harsh polymerization conditions such as a high pressure and the like, in order to increase a molecular weight of the polymer to improve an alignment, which causes difficulty in the mass production of the polymer in terms of facilities and cost.

Accordingly, an article manufactured by injection-molding a conventional liquid crystal polymer has insufficient barrier characteristics, for example, a high water vapor transmission rate (WVTR) of greater than or equal to about 0.07 grams per square meter per day (g/m²/day) at 38° C. and under relative humidity of 100%, as measured according to ISO 15106 or ASTM F1249.

The present inventors provide a battery case including an article molded from a liquid crystal polymer having high heat resistance by improving moisture transmission resistivity and mechanical strength of the liquid crystal polymer by introducing an amide bond into a main chain of a liquid crystal aromatic polymer, which primarily includes ester bonds, as a method of increasing an interaction among polymer chains of the liquid crystal polymer. In other words, a hydrogen atom of the amide bond introduced into the liquid crystal polymer chain forms a hydrogen bond with an oxygen atom of the ester bonds or an oxygen atom of the newly introduced amide bond, and thus increases an interaction among the polymer chains to increase the packing density of the liquid crystal polymer. As a result, the liquid crystal polymer of the present provides for a reduced passage for moisture, that is, a reduced free volume in the polymer, and increased impact strength of the polymer due to a denser structure of the polymer, as well as improving moisture transmission resistivity of the polymer.

Accordingly, a battery case according to an embodiment includes a container configured to house an electrode assembly, wherein the container includes a bottom wall and a plurality of side walls, the bottom wall and the side walls are integrated to define an internal space therein for housing the electrode assembly and to further define a top opening on an opposing side from the bottom wall, at least one of the bottom wall and the side walls includes a liquid crystal aromatic poly(ester amide), and the battery case has a water vapor transmission rate (WVTR) of less than or equal to about 0.07 g/m²/day at a wall thickness of 1 mm, as measured at 38° C. and a relative humidity of 100% according to ISO 15106 or ASTM F1249.

The liquid crystal aromatic poly(ester amide) may be prepared by copolymerization (i.e., is a copolymerization product) of liquid crystal monomers including at least one of an aromatic aminocarboxylic acid represented by Chemical Formula 1 and an aromatic aminophenol represented by Chemical Formula 2, and an aromatic hydroxycarboxylic acid represented by Chemical Formula 3.

Chemical Formula 1 has the formula:

NH₂—Ar¹—COOH Chemical Formula 1

wherein, in Chemical Formula 1, Ar¹ may be a substituted or unsubstituted arylene-containing group, which is a single substituted or unsubstituted C6 to C30 arylene group, a fused ring of two or more substituted or unsubstituted C6 to C30 arylene groups, or two or more substituted or unsubstituted C6 to C30 arylene groups linked by a single bond, —O—, —S—, —SO₂—, —C(═O)—, —CH₂ₙ—, —C(CₙH₂ₙ₊₁)— wherein n ranges from 1 to 10, or —NR— wherein R is hydrogen or a C1 to C5 alkyl group, or a combination thereof.

For example, Ar¹ may be a substituted or unsubstituted phenylene group, a substituted or unsubstituted naphthalenylene group, a substituted or unsubstituted anthracenylene group, a substituted or unsubstituted phenanthrenylene group, a substituted or unsubstituted naphthacenylene group, a substituted or unsubstituted pyrenylene group, or the like, and for example, Ar¹ may be a phenylene group or a naphthalenylene group, but is not limited thereto.

Chemical Formula 2 has the formula:

NH₂—Ar²—OH Chemical Formula 2

wherein, in Chemical Formula 2, Ar² may be a substituted or unsubstituted arylene-containing group, which is a single substituted or unsubstituted C6 to C30 arylene group, a fused ring of two or more substituted or unsubstituted C6 to C30 arylene groups, or two or more substituted or unsubstituted C6 to C30 arylene groups linked by a single bond, —O—, —S—, —SO₂—, —C(═O)—, —CH₂ₙ—, —C(CₙH₂ₙ₊₁)— wherein n ranges from 1 to 10, or —NR— wherein R is hydrogen or a C1 to C5 alkyl group, or a combination thereof.

For example, Ar² may be a substituted or unsubstituted phenylene group, a substituted or unsubstituted naphthalenylene group, a substituted or unsubstituted anthracenylene group, a substituted or unsubstituted phenanthrenylene group, a substituted or unsubstituted naphthacenylene group, a substituted or unsubstituted pyrenylene group, or the like, and for example, Ar² may be a phenylene group or a naphthalenylene group, but is not limited thereto.

Chemical Formula 3 has the formula:

OH—Ar³—COOH Chemical Formula 3

wherein, in Chemical Formula 3, Ar³ may be a substituted or unsubstituted arylene-containing group, which is a single substituted or unsubstituted C6 to C30 arylene group, a confused ring of substituted or unsubstituted two or more C6 to C30 arylene groups, or two or more substituted or unsubstituted C6 to C30 arylene groups linked by a single bond, —O—, —S—, —SO₂—, —C(═O)—, —CH₂ₙ—, —C(CₙH₂ₙ₊₁)— wherein n ranges from 1 to 10, or —NR— wherein R is hydrogen or a C1 to C5 alkyl group, or a combination thereof.

For example, Ar³ may be a substituted or unsubstituted phenylene group, a substituted or unsubstituted naphthalenylene group, a substituted or unsubstituted anthracenylene group, a substituted or unsubstituted phenanthrenylene group, a substituted or unsubstituted naphthacenylene group, a substituted or unsubstituted pyrenylene group, or the like, and for example, Ar³ may be a phenylene group or a naphthalenylene group, but is not limited thereto.

In an exemplary embodiment, the liquid crystal aromatic poly(ester amide) may be prepared by copolymerization (i.e., is a copolymerization product) of liquid crystal monomers including the aromatic aminocarboxylic acid represented by Chemical Formula 1 and the aromatic hydroxycarboxylic acid represented by Chemical Formula 3. The poly(ester amide) prepared by copolymerization of liquid crystal monomers including the aromatic aminocarboxylic acid represented by Chemical Formula 1 and the aromatic hydroxycarboxylic acid represented by Chemical Formula 3 may include structural units represented by Chemical Formula A and Chemical Formula C:

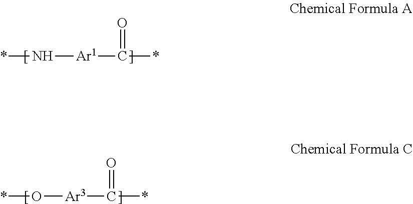

wherein, in Chemical Formula A and Chemical Formula C, Ar¹ and Ar³ are independently the same as defined in Chemical Formula 1 and Chemical Formula 3.

In an example embodiment, the aromatic aminocarboxylic acid represented by Chemical Formula 1 may include 4-aminobenzoic acid, and the aromatic hydroxycarboxylic acid represented by Chemical Formula 3 may include 4-hydroxybenzoic acid.

The aromatic hydroxycarboxylic acid represented by Chemical Formula 3 may further include at least one aromatic hydroxycarboxylic acid that is glycolic acid, 6-hydroxy-2-naphthoic acid, 6-hydroxy-1-naphthoic acid, 3-methyl-4-hydroxybenzoic acid, 3,5-dimethyl-4-hydroxybenzoic acid, 2,6-dimethyl-4-hydroxybenzoic acid, 3-methoxy-4-hydroxybenzoic acid, 3,5-dimethoxy-4-hydroxybenzoic acid, 6-hydroxy-5-methyl-2-naphthoic acid, 6-hydroxy-5-methoxy-2-naphthoic acid, 2-chloro-4-hydroxybenzoic acid, 3-chloro-4-hydroxybenzoic acid, 2,3-dichloro-4-hydroxybenzoic acid, 3,5-dichloro-4-hydroxybenzoic acid, 2,5-dichloro-4-hydroxybenzoic acid, 3-bromo-4-hydroxybenzoic acid, 6-hydroxy-5-chloro-2-naphthoic acid, 6-hydroxy-7-chloro-2-naphthoic acid, 6-hydroxy-5,7-dichloro-2-naphthoic acid, p-β-hydroxyethoxybenzoic acid, or a combination thereof, for example, the aromatic hydroxycarboxylic acid represented by Chemical Formula 3, which is included in addition to the 4-hydroxybenzoic acid, may be 6-hydroxy-2-naphthoic acid, but is not limited thereto.

In an example embodiment, when the aromatic aminocarboxylic acid represented by Chemical Formula 1 includes 4-aminobenzoic acid, and the aromatic hydroxycarboxylic acid represented by Chemical Formula 3 includes 4-hydroxybenzoic acid and 6-hydroxy-2-naphthoic acid, poly(ester amide) prepared from these liquid crystal monomers may include structural units represented by Chemical Formula A-1, Chemical Formula C-1, and Chemical Formula C-2:

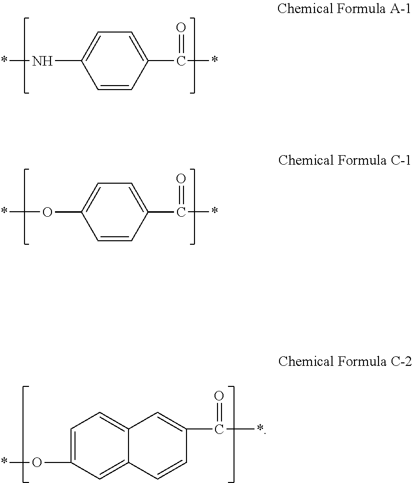

In another example embodiment, the liquid crystal aromatic poly(ester amide) may be prepared by copolymerization of liquid crystal monomers further including at least one of the aromatic dicarboxylic acid represented by Chemical Formula 4, and the aromatic diol represented by Chemical Formula 5, together with the aromatic aminocarboxylic acid represented by Chemical Formula 1, and the aromatic hydroxycarboxylic acid represented by Chemical Formula 3.

Chemical Formula 4 has the formula:

COOH—Ar⁴—COOH Chemical Formula 4

wherein, in Chemical Formula 4, Ar⁴ may be a substituted or unsubstituted arylene-containing group, which is a single substituted or unsubstituted C6 to C30 arylene group, a fused ring of two or more substituted or unsubstituted C6 to C30 arylene groups, or two or more substituted or unsubstituted C6 to C30 arylene groups linked by a single bond, —O—, —S—, —SO₂—, —C(═O)—, —CH₂ₙ—, —C(CₙH₂ₙ₊₁)— wherein n ranges from 1 to 10, or —NR— wherein R is hydrogen or a C1 to C5 alkyl group, or a combination thereof. For example, Ar⁴ may be a substituted or unsubstituted phenylene group, a substituted or unsubstituted naphthalenylene group, a substituted or unsubstituted anthracenylene group, a substituted or unsubstituted phenanthrenylene group, a substituted or unsubstituted naphthacenylene group, a substituted or unsubstituted pyrenylene group, or the like, for example, a substituted or unsubstituted phenylene group or a substituted or unsubstituted naphthalenylene group, but is not limited thereto.

Chemical Formula 5 has the formula:

OH—Ar⁵—OH Chemical Formula 5

wherein, in Chemical Formula 5, Ar⁵ may be a substituted or unsubstituted-containing group, which is a single substituted or unsubstituted C6 to C30 arylene group, a fused ring of two or more substituted or unsubstituted C6 to C30 arylene groups, or two or more substituted or unsubstituted C6 to C30 arylene groups linked by a single bond, —O—, —S—, —SO₂—, —C(═O)—, —CH₂ₙ—, —C(CₙH₂ₙ₊₁)— wherein n ranges from 1 to 10, or —NR— wherein R is hydrogen or a C1 to C5 alkyl group, or a combination thereof. For example, Ar⁵ may be a substituted or unsubstituted phenylene group, a substituted or unsubstituted naphthalenylene group, a substituted or unsubstituted anthracenylene group, a substituted or unsubstituted phenanthrenylene group, a substituted or unsubstituted naphthacenylene group, a substituted or unsubstituted pyrenylene group, or the like, for example, a substituted or unsubstituted phenylene group or a substituted or unsubstituted naphthalenylene group, but is not limited thereto.

The aromatic dicarboxylic acid represented by Chemical Formula 4 may be at least one of terephthalic acid, 4,4′-biphenyldicarboxylic acid, 4,4′-terphenyldicarboxylic acid, 1,6-naphthalenedicarboxylic acid, 2,6-naphthalenedicarboxylic acid, 1,4-naphthalenedicarboxylic acid, 2,7-naphthalenedicarboxylic acid, diphenylether-4,4′-dicarboxylic acid, diphenoxyethane-4,4′-dicarboxylic acid, diphenoxy butane-4,4′-dicarboxylic acid, diphenylethane-4,4′-dicarboxylic acid, isophthalic acid, diphenylether-3,3′-dicarboxylic acid, diphenoxyethane-3,3′-dicarboxylic acid, diphenyl ethane-3,3′-dicarboxylic acid, chloroterephthalic acid, dichloroterephthalic acid, dichloroisophthalic acid, bromoterephthalic acid, methylterephthalic acid, dimethylterephthalic acid, ethylterephthalic acid, methoxyterephthalic acid, or ethoxyterephthalic acid, but is not limited thereto.

The aromatic diol represented by Chemical Formula 5 may be at least one of catechol, resorcinol, hydroquinone, 4,4′-dihydroxybiphenyl, 2,2-bis(4′-β-hydroxyethoxyphenyl)propane, bis(4-hydroxyphenyl)sulfone, bis(4-β-hydroxyethoxyphenyl) sulfonic acid, 9,9′-bis(4-hydroxyphenyl)fluorene, 3,3′-dihydroxybiphenyl, 4,4′-dihydroxyterphenyl, 2,6-naphthalenediol, 4,4′-dihydroxydiphenylether, bis(4-hydroxyphenoxy)ethane, 3,3′-dihydroxydiphenylether, 1,6-naphthalenediol, 2,2-bis(4-hydroxyphenyl)propane, bis(4-hydroxyphenyl)methane, chlorohydroquinone, methylhydroquinone, tert-butylhydroquinone, phenylhydroquinone, methoxyhydroquinone, phenoxyhydroquinone, 4-chlororesorcinol, or 4-methylresorcinol, but is not limited thereto.

When the liquid crystal aromatic poly(ester amide) is prepared by liquid crystal monomers that further include the aromatic dicarboxylic acid represented by Chemical Formula 4 and the aromatic diol represented by Chemical Formula 5, the liquid crystal aromatic poly(ester amide) may further include structural units represented by Chemical Formula D and Chemical Formula E:

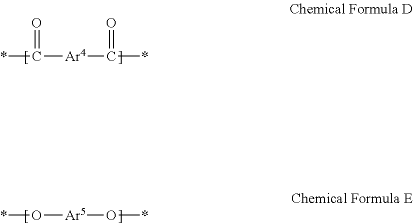

wherein, in Chemical Formula D and Chemical Formula E, Ar⁴ and Ar⁵ are independently the same as defined in Chemical Formula 4 and Chemical Formula 5.

In another example embodiment, the liquid crystal aromatic poly(ester amide) may be prepared by copolymerization of liquid crystal monomers including the aromatic aminophenol represented by Chemical Formula 2 and the aromatic hydroxycarboxylic acid represented by Chemical Formula 3. Herein, the liquid crystal monomer may further include the aromatic dicarboxylic acid represented by Chemical Formula 4.

The liquid crystal aromatic poly(ester amide) prepared by liquid crystal monomers including the aromatic aminophenol represented by Chemical Formula 2, the aromatic hydroxycarboxylic acid represented by Chemical Formula 3, and the aromatic dicarboxylic acid represented by Chemical Formula 4 may include structural units represented by Chemical Formula B to Chemical Formula D:

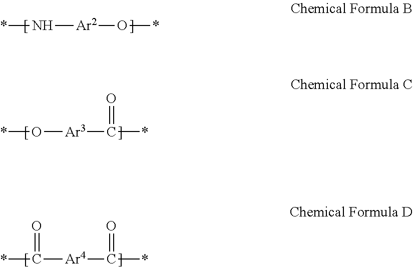

wherein, in Chemical Formula B to Chemical Formula D, Ar² to Ar⁴ are independently the same as defined in Chemical Formula 2 to Chemical Formula 4.

The aromatic aminocarboxylic acid represented by Chemical Formula 1 and the aromatic aminophenol represented by Chemical Formula 2 may be included in an amount of less than or equal to about 20 mol % based on the total mole numbers of the liquid crystal monomers for forming the liquid crystal aromatic poly(ester amide).

As described above, when an amide bond is introduced into a liquid crystal polymer chain mainly consisting of ester bonds, an effect may be increasing packing density of a polymer due to a hydrogen bonding among polymer chains, and thus increasing moisture transmission resistivity and impact strength of the polymer may not only be obtained, but the polymerization conditions such as high pressure, use of a catalyst, vacuum, or the like commonly required to prepare a polymer having a high molecular weight also may not be needed due to high reactivity of the amide bond formation. Accordingly, an effect of simplifying a polymerization process and decreasing a manufacture cost also may be obtained. However, when the aforementioned aromatic aminocarboxylic acid or aromatic aminophenol is included in an amount of greater than about 20 mol % based on a total mole numbers of the liquid crystal monomers, due to a high reaction speed of the formation of the amide bond, the aforementioned aminocarboxylic acid or aminophenol may react first before the other monomers react and thus form a polymer mainly of the amide bond, which has a high melting point, and thus is hardened, and not further polymerized.

Accordingly, in order to include less than or equal to about 20 mol % of an amide structural unit in the liquid crystal aromatic poly(ester amide), an amount of the aromatic aminocarboxylic acid represented by Chemical Formula 1 or the aromatic aminophenol represented by Chemical Formula 2 is adjusted to be less than or equal to about 20 mol % in the liquid crystal monomers. The liquid crystal aromatic poly(ester amide) prepared by including less than or equal to about 20 mol % of the aromatic aminocarboxylic acid and/or aromatic aminophenol has gradually decreasing moisture resistance but gradually increasing impact strength, as an amount of the amide structural unit increases within the range, and accordingly, may be manufactured into a battery case having a low water vapor transmission rate and high impact strength.

In an example embodiment, the aromatic hydroxycarboxylic acid represented by Chemical Formula 3 may include about 25 mol % to about 75 mol % of 4-hydroxybenzoic acid and about 75 to about 25 mol % of another aromatic hydroxycarboxylic acid different from 4-hydroxybenzoic acid based on the total mole number of the aromatic hydroxycarboxylic acid, and for example, the other aromatic hydroxycarboxylic acid different from 4-hydroxybenzoic acid may be 6-hydroxy-2-naphthoic acid. Accordingly, in an example embodiment, the aromatic hydroxycarboxylic acid represented by Chemical Formula 3 may include about 25 mol % to about 75 mol % of 4-hydroxybenzoic acid and about 75 mol % to about 25 mol % of 6-hydroxy-2-naphthoic acid based on the total mole number of the aromatic hydroxycarboxylic acid.

When the liquid crystal polymer is formed by polymerizing 4-hydroxybenzoic acid and 6-hydroxy-2-naphthoic acid alone without including an amide bond structure precursor monomer, even though the 4-hydroxybenzoic acid and 6-hydroxy-2-naphthoic acid may be present in a ratio within the ranges, aromatic polyester prepared therefrom has remarkably low impact strength of less than or equal to about 5.0 kgf/cm². In other words, when about 73 mol % of 4-hydroxybenzoic acid and about 27 mol % of 6-hydroxy-2-naphthoic acid are used to prepare a polyester, the prepared polyester has an impact strength of about 5.0 kgf/cm², and herein, as an amount of the 4-hydroxybenzoic acid is gradually decreased, while an amount of the 6-hydroxy-2-naphthoic acid is gradually increased in the above ratio, the impact strength is further decreased down to about 3.2 kgf/cm². On the other hand, when an amount of the 4-hydroxybenzoic acid is gradually decreased, while an amount of the 6-hydroxy-2-naphthoic acid is gradually increased, moisture transmission resistivity of polyester gradually increases, and thus a water vapor transmission rate of the polymer gradually decreases down to about 0.030 g/m²/day. However, polyester has very low impact strength of about 3.2 kgf/cm², and thus may not be used to manufacture an article requiring greater than or equal to a predetermined level of mechanical strength.

However, as shown in the embodiments described herein, when 4-hydroxybenzoic acid and 6-hydroxy-2-naphthoic acid are copolymerized by changing a ratio within the above ranges, and an aromatic aminocarboxylic acid is added thereto in an amount of less than or equal to about 20 mol % based on the total mole numbers of the liquid crystal monomers, the liquid crystal aromatic poly(ester amide) manufactured therefrom has a water vapor transmission rate gradually decreasing down to less than or equal to about 0.07 g/m²/day and an impact strength gradually increasing up to greater than or equal to about 10.0 kgf/cm². Particularly, as an amount of the aromatic aminocarboxylic acid, for example, 4-aminobenzoic acid increases, a moisture transmission resistivity gradually increases, and simultaneously, an impact strength also increases. For example, when a copolymerization is performed by fixing an amount of 6-hydroxy-2-naphthoic acid as 27 mol %, and reducing an amount of 4-hydroxybenzoic acid from about 65.7 mol % to about 54.8 mol % but adding 4-aminobenzoic acid as much as the reduced amount of 4-hydroxybenzoic acid, a water vapor transmission rate decreases from about 0.069 g/m²/day to about 0.025 g/m²/day, but impact strength increases from about 10.2 kgf/cm² to about 15 kgf/cm². Accordingly, a battery case including the liquid crystal aromatic poly(ester amide) according to an embodiment shows a low water vapor transmission rate of less than or equal to about 0.07 g/m²/day and a high impact strength of greater than or equal to about 10 kgf/cm², and thus may realize excellent water vapor barrier characteristics and mechanical properties.

In an example embodiment, the liquid crystal aromatic poly(ester amide) may be obtained by copolymerizing (i.e., is a copolymer product derived from) about 5 mol % to about 20 mol % of 4-aminobenzoic acid, about 5 mol % to about 70 mol % of 4-hydroxybenzoic acid, and about 25 mol % to about 80 mol % of 6-hydroxy-2-naphthoic acid, and within these ranges, a water vapor transmission rate and an impact strength of the battery case may be adjusted within a desired range by controlling an amount of each liquid crystal monomer. In other words, 5 to 20 mol % of the structural units are derived from 4-aminobenzoic acid, 5 to 70 mol % of the structural units are derived from 4-hydroxybenzoic acid, and about 25 to about 80 mol % of the structural units are derived from 6-hydroxy-2-naphthoic acid. For example, the liquid crystal aromatic poly(ester amide) may be prepared by copolymerizing 4-aminobenzoic acid in an amount of about 6 mol % to about 19 mol %, for example, about 7 mol % to about 18.5 mol %, 4-hydroxybenzoic acid in an amount of about 6 mol % to about 68 mol %, for example, about 6.5 mol % to about 67 mol %, and 6-hydroxy-2-naphthoic acid in an amount of about 25 mol % to about 75 mol %, for example, about 26 mol % to about 75 mol %.

Within the content ranges, as an amount of 4-aminobenzoic acid is increased, a water vapor transmission rate of an article including the liquid crystal aromatic poly(ester amide) will gradually decrease, while impact strength thereof gradually increases. On the other hand, within the content ranges, when a maximum amount of 4-aminobenzoic acid is used, and an amount of 4-hydroxybenzoic acid is smaller than that of 6-hydroxy-2-naphthoic acid, a water vapor transmission rate may be the same as before or a little decreased, but impact strength may be a little more decreased.

For example, in an article including liquid crystal aromatic poly(ester amide) prepared from liquid crystal monomers within the amount ranges, a water vapor transmission rate (WVTR) at a wall thickness of 1 mm, as measured at 38° C. and a relative humidity of 100% according to ISO 15106 or ASTM F1249, may be less than or equal to about 0.07 g/m²/day, for example, less than or equal to about 0.069 g/m²/day, less than or equal to about 0.065 g/m²/day, less than or equal to about 0.060 g/m²/day, less than or equal to about 0.055 g/m²/day, less than or equal to about 0.050 g/m²/day, less than or equal to about 0.045 g/m²/day, less than or equal to about 0.040 g/m²/day, less than or equal to about 0.035 g/m²/day, less than or equal to about 0.030 g/m²/day, less than or equal to about 0.025 g/m²/day, less than or equal to about 0.024 g/m²/day, less than or equal to about 0.023 g/m²/day, or less than or equal to about 0.022 g/m²/day, but is not limited thereto. This water vapor transmission rate decrease is a remarkably improved result, which has not been accomplished in a conventional plastic or plastic-based article including a liquid crystal polymer.

In addition, in the case of an article including liquid crystal aromatic poly(ester amide) prepared from the liquid crystal monomers within the amount ranges, an impact strength measured according to ASTM D265 may be greater than or equal to about 10 kgf/cm², greater than or equal to about 10.1 kgf/cm², greater than or equal to about 10.2 kgf/cm², greater than or equal to about 10.5 kgf/cm², greater than or equal to about 11.0 kgf/cm², greater than or equal to about 11.5 kgf/cm², greater than or equal to about 12.0 kgf/cm², greater than or equal to about 12.5 kgf/cm², greater than or equal to about 13.0 kgf/cm², greater than or equal to about 13.1 kgf/cm², greater than or equal to about 13.2 kgf/cm², greater than or equal to about 13.5 kgf/cm², greater than or equal to about 13.7 kgf/cm², greater than or equal to about 13.9 kgf/cm², greater than or equal to about 14.0 kgf/cm², greater than or equal to about 14.3 kgf/cm², greater than or equal to about 14.5 kgf/cm², greater than or equal to about 14.7 kgf/cm², or greater than or equal to about 15.0 kgf/cm², but is not limited thereto. This impact strength increase is remarkably improved compared with a liquid crystal polymer including no amide bond but conventionally an ester bond alone.

A battery case manufactured from an article having this decreased water vapor transmission rate and this increased impact strength according to an embodiment may have a similar water vapor transmission rate and impact strength to those of a metal-containing battery case, but furthermore may be much lighter than the conventional metal-based battery case, and freely manufactured to have a desired shape and size.

In an example embodiment, the battery case has a bottom wall and a plurality of sidewalls forming the container, of which at least one of the bottom wall or sidewall may include the liquid crystal aromatic poly(ester amide), for example, all of the bottom wall and the plurality of sidewalls may include the aromatic poly(ester amide). In addition, herein, at least one of the bottom wall and the plurality of sidewalls or all of the bottom wall and the plurality of sidewalls may be included in an article manufactured from the aromatic poly(ester amide). The container may be formed by integrating the bottom wall and the plurality of side walls, wherein the “integrated” refers to a combination of the bottom wall with the plurality of side walls to form one shape, or refers to connection of the bottom wall with the plurality of side walls except the top opening to form a container shape. The integrating method is not particularly limited, and for example, as described herein, the aromatic poly(ester amide) is molded in a form of a container having the bottom wall and the plurality of side walls in one step, or is molded into separate articles of the bottom wall and the plurality of side walls and then they are connected by known methods of welding or adhering to form an integrated shape.

The liquid crystal poly(ester amide) according to an embodiment may have a melting point of less than or equal to about 300° C.

As described above, a liquid crystal polymer such as a polyester has a high melting point and thus insufficient melting workability, but the liquid crystal poly(ester amide) according to an embodiment has a melting point within the range and thus may be easily molded using a publicly known molding method.

As described above, since the battery case according to an embodiment has remarkably improved moisture transmission resistivity and mechanical strength, which may not be accomplished by a conventional plastic article including plastic or liquid crystal polymer, an electrode assembly including positive and negative electrodes may be directly inserted therein to form a battery without being wrapped with an additional exterior material, such as, for example, a metal pouch, and the battery case manufactured in this way has improved durability. Conventionally, an electrode assembly including positive and negative electrodes is formed, and then, wrapped with a metal pouch having moisture transmission resistivity to form a battery cell, and then, packed in a metallic battery case having a battery cell container to manufacture a battery or a battery module, which is complicated in terms of a process, takes a long time, and higher costs.

As described above, the battery case according to an embodiment may have remarkably improved moisture transmission resistivity and mechanical strength, since a bottom wall and at least one of a plurality of side walls forming the container, for example, both the bottom wall and the plurality of side walls is included in an article of the liquid crystal poly(ester amide). Herein, as described above, the battery case may be sealed by covering and sealing the top opening of the container of the battery case with a lid covering at least a part of the top opening, for example, the entire top opening. Herein, the lid may also be manufactured from an article including the liquid crystal poly(ester amide) which forms the container of the battery case.

A method of producing an article is not particularly limited and may be appropriately selected. For example, the article may be obtained by molding a composition including the liquid crystal poly(ester amide) to obtain a pellet and molding the pellet to have a desired shape through an extrusion molding machine or an injection molding machine. A kind of the extrusion molding machine and the injection molding machine is not particularly limited, but may be known in the related art. This extrusion molding machine or injection molding machine is commercially available. In addition, the molding may include known various methods, such as, for example, an extrusion molding, an injection molding, a blow molding, a press molding, or the like, to obtain a desired size and shape.

Hereinafter, a battery case according to an embodiment is described with reference to the drawings.

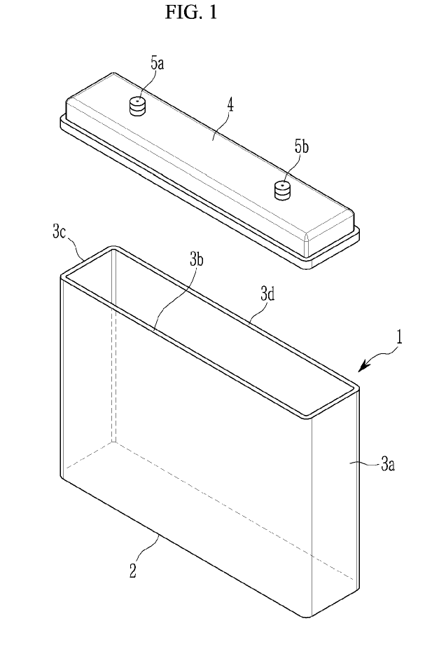

FIG. 1 is an exploded perspective view of a battery case according to an embodiment.

Referring to FIG. 1, a battery case according to an embodiment includes a container 1 including a bottom wall 2 and a plurality of (e.g., 3, 4, or greater) side walls 3a, 3b, 3c, and 3d that are integrated to provide an internal space for housing an electrode assembly. The container 1 has a top opening opposed to the bottom wall 2 and an electrode assembly may be housed (i.e., disposed) in the internal space of the container 1 through the top opening. The battery case may further include a lid 4 to cover (or seal) at least a part, for example, the entire top opening of the container 1. The lid 4 may have at least one of the positive terminal 5a and the negative terminal 5b (e.g., positive terminal and negative terminal). The lid 4 may include the same material as the container 1 or a different material from the container 1.

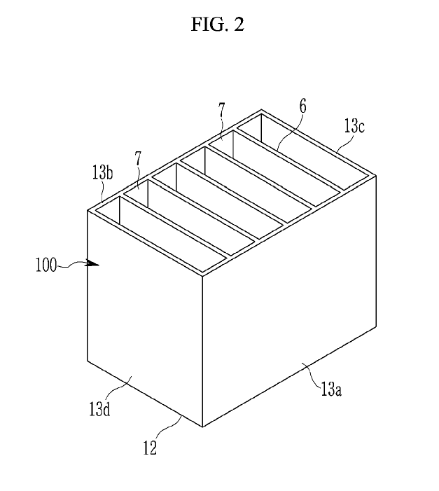

FIG. 2 is an exploded perspective view of a battery case according to another embodiment.

Referring to FIG. 2, a container 100 of a battery case according to an example embodiment includes a plurality of sidewalls 13a, 13b, 13c, and 13d, and a bottom wall 12 that are integrated to provide an internal space, and one or more, for example 2, 3, 4, 5, or 6, partition walls are provided in the space. The internal space in the container 100 may include a plurality of, for example, 2 or more, for example, 3 or more, for example, 4 or more, or 5 or more cell compartments 7 defined by the partition walls. An electrode assembly including a positive electrode and a negative electrode may be housed in each cell compartment 7 that will be described herein.

FIGS. 1 and 2 show embodiments of a rectangular parallelepiped battery case, but the battery case according to an embodiment has no limit to the shape but may have various shapes and sizes and the various numbers of containers and cell compartments.

A battery or a battery module according to an embodiment may be manufactured by housing an electrode assembly including positive and negative electrodes in the container 1 of the battery case in FIG. 1 or respectively in the internal spaces of a plurality of cell compartments 7 in the container 100 in FIG. 2. This battery or battery module is manufactured by housing the electrode assembly in the internal space of container 1 or respectively in the cell compartments 7 of the battery case in FIG. 1 or 2 and then, injecting an electrolyte solution into the container 1 or the cell compartments 7 to supply the electrode assembly with the electrolyte solution. After injecting the electrolyte solution into the container 1 or the cell compartment 7 in which the electrode assembly is disposed, a top opening or open side of each battery case is closed or sealed with the lid 4 to manufacture the battery or battery module according to an embodiment.

Hereinafter, the electrode assembly is described.

The electrode assembly includes a positive electrode, a negative electrode, and a separator disposed therebetween. The electrode assembly may further include, for example an aqueous or non-aqueous electrolyte solution in the separator. The kinds of the electrode assembly are not particularly limited. In an embodiment, the electrode assembly may include an electrode assembly for a rechargeable lithium battery. The positive electrode, the negative electrode, the separator, and the electrolyte solution of the electrode assembly may be desirably selected according to kinds of the electrode and are not particularly limited. Hereinafter, the electrode assembly for a rechargeable lithium battery is exemplified but the present disclosure is not limited thereto.

The positive electrode may include, for example, a positive active material disposed on a positive current collector and may further include at least one of a conductive material and a binder. The positive electrode may further include a filler. The negative electrode may include, for example a negative active material disposed on a negative current collector and may further include at least one of a conductive material and a binder. The negative electrode may further include a filler.

The positive active material may include, for example a (solid solution) oxide including lithium but is not particularly limited as long as it is a material capable of intercalating and deintercalating lithium ions electrochemically. The positive active material may be a layered compound such as lithium cobalt oxide (LiCoO₂), lithium nickel oxide (LiNiO₂), or the like, a compound substituted with one or more transition metals; a lithium manganese oxide such as chemical formulae Li₁₊ₓMn₂₋ₓO₄ (wherein, x is 0 to 0.33), LiMnO₃, LiMn₂O₃, LiMnO₂, or the like; lithium copper oxide (Li₂CuO₂); vanadium oxide such as LiV₃O₈, LiFe₃O₄, V₂O₅, Cu₂V₂O₇, or the like; a Ni site-type lithium nickel oxide represented by chemical formula LiNi₁₋ₓMxO₂ (wherein, M=Co, Mn, Al, Cu, Fe, Mg, B, or Ga and x=0.01 to 0.3); a lithium manganese composite oxide represented by chemical formula LiMn₂₋ₓMₓO₂ (wherein, M=Co, Ni, Fe, Cr, Zn, or Ta and x=0.01 to 0.1) or Li₂Mn₃MO₈ (wherein, M=Fe, Co, Ni, Cu, or Zn); LiMn₂O₄ where a part of Li of chemical formula is substituted with an alkaline-earth metal ion; a disulfide compound; Fe₂(MoO₄)₃, or the like, but is not limited thereto.

Examples of the conductive material may be carbon black such as Ketjen black, acetylene black, or the like, natural graphite, artificial graphite, or the like, but is not particularly limited as long as it may increase conductivity of the positive electrode.

The binder may be for example, polyvinylidene fluoride, an ethylene-propylene-diene terpolymer, a styrene-butadiene rubber, an acrylonitrile-butadiene rubber, a fluorine rubber, polyvinyl acetate, polymethylmethacrylate, polyethylene, nitrocellulose, or the like, but is not particularly limited as long as it may bind the (positive or negative) active material and the conductive material on the current collector. Examples of the binder may be polyvinyl alcohol, carboxylmethyl cellulose (CMC), starch, hydroxypropyl cellulose, recycled cellulose, tetrafluoroethylene, polyethylene, polypropylene, an ethylene-propylene-diene polymer (EPDM), sulfonated EPDM, a styrene-butylene rubber, a fluorine rubber, various copolymers, polymeric highly saponified polyvinyl alcohol, or the like, in addition to the foregoing materials.

The negative active material may be for example, carbon and graphite materials such as natural graphite, artificial graphite, expanded graphite, carbon fiber, non-graphitizable carbon, carbon black, carbon nanotube, fullerene, activated carbon, or the like; a metal such as Al, Si, Sn, Ag, Bi, Mg, Zn, In, Ge, Pb, Pd, Pt, Ti, or the like that may be an alloy with lithium and a compound including such an element; a composite material of a metal and a compound thereof, and carbon and graphite materials; a lithium-containing nitride, or the like. Among them, carbonaceous active materials, silicon-containing active materials, tin-containing active materials, or silicon-carbon active materials may be desirably used and may be used alone or in a combination of two or more.

The separator is not particularly limited and may be any separator of a rechargeable lithium battery. For example, a porous film or non-woven fabric having excellent high rate discharge performance may be used alone or in a mixture thereof. The separator may include pores and the pores may have generally a pore diameter of about 0.01 micrometers (μm) to about 10 μm and a thickness of about 5 μm to about 300 μm. A substrate of the separator may include, for example, a polyolefin-based resin, a polyester resin, polyvinylidene fluoride (PVDF), a vinylidene fluoride-hexafluoropropylene copolymer, a vinylidene fluoride-perfluorovinylether copolymer, a vinylidene fluoride-tetrafluoroethylene copolymer, a vinylidene fluoride-trifluoroethylene copolymer, a vinylidene fluoride-fluoroethylene copolymer, a vinylidene fluoride-hexafluoroacetone copolymer, a vinylidene fluoride-ethylene copolymer, a vinylidene fluoride-propylene copolymer, a vinylidene fluoride-trifluoropropylene copolymer, a vinylidene fluoride-tetrafluoroethylene-hexafluoropropylene copolymer, a vinylidene fluoride-ethylene-tetrafluoroethylene copolymer, or the like. When the electrolyte is a solid electrolyte such as a polymer, the solid electrolyte may function as a separator.

The conductive material is a component to further improve conductivity of an active material and may be included in an amount of about 1 weight percent (wt %) to about 30 wt % based on a total weight of the electrode, but is not limited thereto. Such a conductive material is not particularly limited as long as it does not cause chemical changes of a battery and has conductivity, and may be for example, graphite such as natural graphite or artificial graphite; carbon black such as carbon black, acetylene black, Ketjen black, channel black, furnace black, lamp black, summer black, and the like; a carbon derivative such as carbon nanotube, fullerene, or the like, a conductive fiber such as a carbon fiber or a metal fiber, or the like; carbon fluoride, a metal powder such as aluminum, a nickel powder, or the like; a conductive whisker such as zinc oxide, potassium titanate, or the like; a conductive metal oxide such as a titanium oxide; a conductive material such as a polyphenylene derivative, or the like.

The filler is an auxiliary component to suppress expansion of an electrode, and is not particularly limited as long as it does not cause undesirable chemical changes to a battery and is a fiber-shaped material, and may be for example, an olefin-based polymer such as polyethylene, polypropylene, or the like; or a fiber-shaped material such as a glass fiber, a carbon fiber, or the like.

In the electrode, the current collector may be a site of electron transport in an electrochemical reaction of the active material and may be a negative current collector and a positive current collector according to the kind of the electrode. The negative current collector may have a thickness of about 3 μm to about 500 μm. The negative current collector is not particularly limited as long as it does not cause undesirable chemical changes to a battery and has conductivity and may be, for example, copper, stainless steel, aluminum, nickel, titanium, fired carbon, copper or stainless steel that is surface-treated with carbon, nickel, titanium, silver, or the like, an aluminum-cadmium alloy, or the like.

The positive current collector may have a thickness of about 3 μm to about 500 μm, but is not limited thereto. Such a positive current collector is not particularly limited as long as it does not cause undesirable chemical changes to a battery and has high conductivity and may be, for example, stainless steel, aluminum, nickel, titanium, fired carbon, or aluminum or stainless steel that is surface-treated with carbon, nickel, titanium, silver, or the like.

The current collectors may have a fine concavo-convex shape on its surface to reinforce a binding force of the active material and may be used in various shapes of a film, a sheet, a foil, a net, a porous film, a foam, a non-woven fabric, or the like.

The lithium-containing non-aqueous electrolyte solution may comprise, consist essentially of, or consist of a non-aqueous electrolyte and a lithium salt.

The non-aqueous electrolyte may be, for example, an aprotic organic solvent such as N-methyl-2-pyrrolidinone, propylene carbonate, ethylene carbonate, butylene carbonate, dimethyl carbonate, diethyl carbonate, gamma-butyrolactone, 1,2-dimethoxyethane, tetrahydroxy Franc, 2-methyltetrahydrofuran, dimethylsulfoxide, 1,3-dioxolane, formamide, dimethylformamide, dioxolane, acetonitrile, nitromethane, methyl formate, methyl acetate, phosphoric acid triester, trimethoxymethane, a dioxolane derivative, sulfolane, methyl sulfolane, 1,3-dimethyl-2-imidazolidinone, a propylene carbonate derivative, a tetrahydrofuran derivative, an ether, methyl propionate, ethyl propionate, or the like.

The lithium salt is a material that is dissolved in the non-aqueous electrolyte solution and may be, for example, LiCl, LiBr, LiI, LiClO₄, LiBF₄, LiB₁₀Cl₁₀, LiPF₆, LiCF₃SO₃, LiCF₃CO₂, LiAsF₆, LiSbF₆, LiAlCl₄, CH₃SO₃Li, CF₃SO₃Li, (CF₃SO₂)₂NLi, lithium chloroborate, a lithium salt of a lower aliphatic carbonate, lithium fluorophenyl borate, lithium imide, or the like.

An organic solid electrolyte, an inorganic solid electrolyte, or the like may be used.

The organic solid electrolyte may be, for example, a polyethylene derivative, a polyethylene oxide derivative, a polypropylene oxide derivative, a phosphoric acid ester polymer, a poly agitation lysine, polyester sulfide, polyvinyl alcohol, polyvinylidene fluoride, a polymer including an ionic leaving group, or the like.

The inorganic solid electrolyte may be, for example, nitrides of Li such as Li₃N, LiI, Li₅NI₂, Li₃N—LiI—LiOH, LiSiO₄, LiSiO₄—LiI—LiOH, Li₂SiS₃, Li₄SiO₄, Li₄SiO₄—LiI—LiOH, Li₃PO₄—Li₂S—SiS₂, or the like, or halides, sulfates, or the like.

The non-aqueous electrolyte solution may include, for example, pyridine, triethylphosphite, triethanolamine, a cyclic ether, ethylene diamine, n-glyme, hexaphosphoric triamide, a nitrobenzene derivative, sulfur, a quinone-imine dye, N-substituted oxazolidinone, N,N-substituted imidazolidine, ethylene glycol dialkylether, an ammonium salt, pyrrole, 2-methoxyethanol, or aluminum trichloride in order to improve charge and discharge characteristics, flame retardancy, or the like. As needed, in order to endow inflammability, a halogen-containing solvent such as carbon tetrachloride, ethylene trifluoride, or the like may be further added and in order to improve high temperature storage characteristics, carbon dioxide gas may be further added.

As described above, a battery module including a battery case according to an embodiment does not need manufacture of a unit cell including exterior materials consisting of additional moisture transmission resistivity materials on each electrode assembly, and thus an electrode assembly housed in the container of the battery case or each cell compartment in the container does not need additional exterior materials.

In another embodiment, the liquid crystal poly(ester amide) is a copolymer having structural units derived from about 5 mol % to about 20 mol % of 4-aminobenzoic acid, about 5 mol % to about 70 mol % of 4-hydroxybenzoic acid, and about 25 mol % to about 80 mol % of 6-hydroxy-2-naphthoic acid.

In an example embodiment, the liquid crystal poly(ester amide) is a copolymer having structural units derived from about 5 mol % to about 19 mol % of 4-aminobenzoic acid, about 6 mol % to about 70 mol % of 4-hydroxybenzoic acid, and about 25 mol % to about 77 mol % of 6-hydroxy-2-naphthoic acid.

As described above, the liquid crystal poly(ester amide) according to an embodiment may provide a liquid crystal polymer having remarkably increased impact strength and thus increased mechanical properties, as well as increased moisture transmission resistivity, by introducing an amide bond into a polymer main chain to increase an interaction among polymer chains, and thus, to increase a packing density of the polymer chains compared with a conventional liquid crystal polyester including an ester bond. Since the liquid crystal poly(ester amide) has a melting point within a range within which it is easily moldable under typical molding conditions, an article molded from the liquid crystal aromatic poly(ester amide) according to an embodiment may be applied for various uses requiring moisture transmission resistivity and mechanical strength.

On the other hand, the liquid crystal poly(ester amide) according to an embodiment may be prepared by copolymerizing the aforementioned liquid crystal monomers in a liquid crystal polyester-manufacturing method which is well known in a related art except for further adding the aromatic aminocarboxylic acid and/or aromatic aminophenol as a liquid crystal monomer. For example, the liquid crystal aromatic poly(ester amide) may be prepared from the liquid crystal monomers by adding acetic anhydride to a mixture of at least one of aromatic aminocarboxylic acid and aromatic aminophenol with a liquid crystal monomer including an aromatic hydroxycarboxylic acid to cap a terminal end of the liquid crystal monomers and acetylate them, and then, condensing the monomers having the acetylated terminal end. The condensation reaction acetylates one terminal end of the monomer, and thus converts acetic anhydride into acetic acid, and this acetic acid is recovered as a reaction byproduct, and an amount of the recovered acetic acid may be used to calculate a polymerization degree of the monomer.

In addition, the liquid crystal poly(ester amide) according to an embodiment and an article manufactured therefrom are the same as aforementioned, and thus will not be illustrated in further detail.

Hereinafter, the embodiments are described with reference to examples and comparative examples. The following examples and comparative examples are exemplary and do not limit the scope of the present disclosure.

### EXAMPLES

### Example 1: Preparation of Liquid Crystal Poly(Ester Amide)

A 200 milliliter (mL) glass reactor equipped with a torque meter, a thermometer, and a reflux condenser is assembled by putting 66 grams (g) of 4-hydroxybenzoic acid (HBA), 36.95 g of 6-hydroxy-2-naphthoic acid (HNA), 7.28 g of 4-aminobenzoic acid (ABA), and 96.53 g of acetic anhydride, and then, heated up to 140° C. of the reaction temperature at 150 revolutions per minute (rpm) for 30 minutes, and maintained at 140° C. for one hour. Subsequently, the reflux condenser is replaced with a dean-stark condenser, and the temperature is slowly increased up to 330° C. for 2 hours. Herein, 50 mg of TiOBu₄ is added thereto at 300° C. When the temperature reaches 330° C., a pressure in the reactor is slowly reduced for 5 minutes until it reaches 650 Torr, and after the pressure reaches 650 Torr, when a stirring torque becomes 0.4 A, a reaction is stopped to recover a polymerization product.

### Example 2: Preparation of Liquid Crystal Poly(Ester Amide)

A reaction proceeds according to the same as Example 1, except for putting 59 g of 4-hydroxybenzoic acid (HBA), 37.16 g of 6-hydroxy-2-naphthoic acid (HNA), 14.64 g of 4-aminobenzoic acid (ABA), and 97.07 g of acetic anhydride into a 200 mL glass reactor equipped with a torque meter, a thermometer, and a reflux condenser, but not applying vacuum thereto.

### Example 3: Preparation of Liquid Crystal Poly(Ester Amide)

A reaction proceeds according to the same as Example 2, except for putting 57 g of 4-hydroxybenzoic acid (HBA), 37.06 g of 6-hydroxy-2-naphthoic acid (HNA), 16.43 g of 4-aminobenzoic acid (ABA), and 96.81 g of acetic anhydride into a 200 mL glass reactor equipped with a torque meter, a thermometer, and a reflux condenser, but not using a catalyst.

### Example 4: Preparation of Liquid Crystal Poly(Ester Amide)

A reaction proceeds according to the same as Example 3, except for putting 55 g of 4-hydroxybenzoic acid (HBA), 36.95 g of 6-hydroxy-2-naphthoic acid (HNA), 18.20 g of 4-aminobenzoic acid (ABA), and 96.53 g of acetic anhydride into a 200 mL glass reactor equipped with a torque meter, a thermometer, and a reflux condenser.

### Example 5: Preparation of Liquid Crystal Poly(Ester Amide)

A reaction proceeds according to the same as Example 3, except for putting 27 g of 4-hydroxybenzoic acid (HBA), 58.02 g of 6-hydroxy-2-naphthoic acid (HNA), 15.48 g of 4-aminobenzoic acid (ABA), and 81.84 g of acetic anhydride into a 200 mL glass reactor equipped with a torque meter, a thermometer, and a reflux condenser.

### Example 6: Preparation of Liquid Crystal Poly(Ester Amide)

A reaction proceeds according to the same as Example 3, except for putting 5.3 g of 4-hydroxybenzoic acid (HBA), 80.83 g of 6-hydroxy-2-naphthoic acid (HNA), 14.37 g of 4-aminobenzoic acid (ABA), and 76.01 g of acetic anhydride into a 200 mL glass reactor equipped with a torque meter, a thermometer, and a reflux condenser.

### Comparative Example 1: Preparation of Liquid Crystal Polyester

A reaction proceeds according to the same as Example 1, except for putting 73 g of 4-hydroxybenzoic acid (HBA), 36.79 g of 6-hydroxy-2-naphthoic acid (HNA), and 88.70 g of acetic anhydride into a 200 mL glass reactor equipped with a torque meter, a thermometer, and a reflux condenser, and then, slowly reducing a pressure by 50 Torr for 30 minutes, when a temperature of the reactants reaches 330° C.

### Comparative Example 2: Preparation of Liquid Crystal Polyester

A reaction proceeds according to the same as Example 1, except for putting 47 g of 4-hydroxybenzoic acid (HBA), 64.03 g of 6-hydroxy-2-naphthoic acid (HNA), and 83.37 g of acetic anhydride into a 200 mL glass reactor equipped with a torque meter, a thermometer, and a reflux condenser, and then, slowly reducing a pressure by 50 Torr for 30 minutes, when a temperature of the reactants reaches 330° C.

### Comparative Example 3: Preparation of Liquid Crystal Polyester

A reaction proceeds according to the same as Example 1, except for putting 22 g of 4-hydroxybenzoic acid (HBA), 89.92 g of 6-hydroxy-2-naphthoic acid (HNA), and 78.05 g of acetic anhydride into a 200 mL glass reactor equipped with a torque meter, a thermometer, and a reflux condenser, and then, slowly reducing a pressure by 50 Torr for 30 minutes, when a temperature of the reactants reaches 330° C.

### Comparative Example 4: Preparation of Liquid Crystal Poly(Ester Amide)

A reaction proceeds according to the same as Example 4, except for putting 52 g of 4-hydroxybenzoic acid (HBA), 37.43 g of 6-hydroxy-2-naphthoic acid (HNA), 22.13 g of 4-aminobenzoic acid (ABA), and 97.78 g of acetic anhydride into a 200 mL glass reactor equipped with a torque meter, a thermometer, and a reflux condenser. However, in the present experiment, a reaction partially proceeds, but the reactants are not polymerized any more but hardened. The reason is that since a reaction speed of the 4-aminobenzoic acid is too fast, the 4-aminobenzoic acid reacts and forms an amide-bonding product having a high melting point, as an amount of this monomer is increased.

### Comparative Example 5: Preparation of Liquid Crystal Poly(Ester Amide)

A reaction proceeds according to the same as Example 5, except for putting 44 g of 4-hydroxybenzoic acid (HBA), 36.95 g of 6-hydroxy-2-naphthoic acid (HNA), 29.13 g of 4-aminobenzoic acid (ABA), and 96.53 g of acetic anhydride into a 200 mL glass reactor equipped with a torque meter, a thermometer, and a reflux condenser. In the present invention, a reactant is not continuously polymerized due to an increased amount of 4-aminobenzoic acid, and hardened like in Comparative Example 4.

### Evaluation

The compositions and inherent viscosity of the liquid crystal poly(ester amide)s according to Examples 1 to 6 and the liquid crystal polyesters according to Comparative Examples 1 to 3, and a water vapor transmission rate (WVTR), impact strength, and other properties of an article injection-molded from the poly(ester amide)s or polyesters are measured, and the results are shown in Table 1.

Specifically, the liquid crystal polymers according to the Examples and Comparative Examples are respectively pulverized to have a length of less than or equal to about 1 cm with a grinder, mixed while injected into an extruder heated at 280° C. and including two screw axes spinning in the same direction, and injection-molded at 310° C. to manufacture a disk-shaped article having a thickness of about 1 mm and a diameter of 30 mm. A water vapor transmission rate, tensile strength, and impact strength of each article are measured, and the results are shown in Table 1. Methods for measuring the water vapor transmission rate, tensile strength, and impact strength are as follows.

(1) Water Vapor Transmission Rate (WVTR): measured according to ISO15106, or ASTM F1249, by using an Aquatran equipment (Mocon Inc.) at 38° C. under relative humidity of 100%.

(2) Tensile Strength: measured according to ASTM D638 by using QC-506BA made by Cometech Testing Machine Co., Ltd. at a tensile speed of 50 mm/min. Tensile strength is reported as kilograms-force per cubic centimeter.

(3) Impact Strength: Un-notched type Izod impact strength is measured according to ASTM D265 by using an impactor II, CEAST 9050 made by Instron Corp). Impact strength is reported as kilojoules per square meter (kJ/m²).

TABLE 1

| | | | | Characteristics | | | |
|---|---|---|---|---|---|---|---|
| | Mole ratio of raw | | | | Impact | Tensile | Intrinsic |
| | materials (mol %) | | | WVTR | strength | strength | viscosity |
| | HBA | HNA | ABA | (g/m²/day) | (kJ/m²) | (kgf/cm²) | (dl/g) |
| Example 1 | 65.7 | 27 | 7.3 | 0.069 | 10.2 | 1542 | 8.12 |
| Example 2 | 58.4 | 27 | 14.6 | 0.047 | 13.2 | 1652 | 8.06 |
| Example 3 | 56.6 | 27 | 16.4 | 0.035 | 13.9 | 1468 | 7.49 |
| Example 4 | 54.8 | 27 | 18.3 | 0.025 | 15 | 1532 | 7.52 |
| Example 5 | 31.7 | 50 | 18.3 | 0.025 | 13.1 | 1494 | 8.54 |
| Example 6 | 6.7 | 75 | 18.3 | 0.022 | 11 | 1567 | 8.75 |
| Comparative | 73 | 27 | — | 0.076 | 5.0 | 1621 | 8.46 |
| Example 1 | | | | | | | |
| Comparative | 50 | 50 | — | 0.041 | 4.1 | 1645 | 8.95 |
| Example 2 | | | | | | | |
| Comparative | 25 | 75 | — | 0.030 | 3.2 | 1197 | 9.21 |
| Example 3 | | | | | | | |

As shown in Table 1, a water vapor transmission rate of articles respectively manufactured from the liquid crystal polyesters including no ABA (4-aminobenzoic acid), aromatic aminocarboxylic acid, according to Comparative Examples 1 to 3 tends to decrease from a maximum value of 0.076 g/m²/day depending on a ratio of 4-hydroxybenzoic acid (HBA) and 6-hydroxy-2-naphthoic acid (HNA), but simultaneously, an impact strength thereof may sharply decrease from a maximum value of 5.0 kgf/cm² to 3.2 kgf/cm². Particularly, when the water vapor transmission rate is 0.030 g/m²/day, an impact strength is only 3.2 kgf/cm², and this article may not be used for a product requiring high mechanical properties, such as, for example, a high impact strength, as well as a moisture transmission resistivity. In addition, when the water vapor transmission rate is relatively high at 0.076 g/m²/day, the impact strength is still low at 5.0 kgf/cm², and the articles respectively manufactured from the liquid crystal polyester including no amide bond according to Comparative Examples 1 to 3 may not be suitable for a use requiring high mechanical properties.

On the other hand, articles respectively manufactured from the aromatic poly(ester amide)s prepared by using HNA in the same amount as that of Comparative Example 1 but replacing a partial amount of HBA with ABA, articles manufactured from the aromatic aminocarboxylic acid according to Examples 1 to 4 show greater than or equal to twice increased impact strength compared with those not including ABA according to Comparative Example 1. Herein, the water vapor transmission rate of the article somewhat decreases, and is lower than 0.07 g/m²/day, which is a minimum water vapor transmission rate of a conventional liquid crystal polymer. In addition, when an amount of ABA is increased up to 18.3 mol %, as the amount of ABA increases, the impact strength increases, and simultaneously, the water vapor transmission rate unexpectedly decreases to 0.025 g/m²/day. In other words, an article including the aromatic poly(ester amide) according to an embodiment or a battery case including the article may realize a low water vapor transmission rate and simultaneously, high impact strength.

On the other hand, articles respectively manufactured from poly(ester amide) according to Examples 5 and 6 by changing each amount of HBA and HNA within a similar range to those of Comparative Examples 2 and 3, while a relatively high amount of ABA is maintained like in Example 4, maintain a very low water vapor transmission rate like that of Example 4 and show a smaller decrease in impact strength but still maintains greater than or equal to twice the impact strength compared with those including no aromatic aminocarboxylic acid according to Comparative Examples 1 to 3. In other words, as an amide bond is introduced into the liquid crystal aromatic polyester, an interaction among polymer chains increases, and thus packing density of the polymer increases, and accordingly, an article manufactured from the aromatic poly(ester amide) shows a low water vapor transmission rate and remarkably increased impact strength, and thus may be suitable for various uses requiring a low water vapor transmission rate and high mechanical properties.

As shown in Table 1, tensile strength unlike impact strength is not completely proportional to an amount of ABA and the like. In addition, articles according to some Examples show lower tensile strength than that of the articles according to Comparative Examples 1 and 2. However, when an article is manufactured from a liquid crystal polymer, mechanical properties of the article mainly depends on impact strength, but are relatively less influenced by tensile strength.

As for inherent viscosity, comparing Examples 1 to 4 using 27 mol % of HNA with Comparative Example 1, liquid crystal polymers including ABA by replacing a partial amount of HBA according to Examples 1 to 4 show lower inherent viscosity than that of Comparative Example 1. In other words, when a predetermined amount of ABA is added, inherent viscosity of the liquid crystal polymers rather decreases, even though impact strength increases due to polymer packing, and thus may have a positive influence on a manufacturing process of the article. The inherent viscosity tends to increase, as an amount of HNA increases.

While this disclosure has been described in connection with one or more example embodiments, it is to be understood that the disclosure is not limited to the disclosed exemplary embodiments, but, on the contrary, is intended to cover various modifications and equivalent arrangements included within the spirit and scope of the appended claims.

What is claimed is:

1. A battery case comprising
a container configured to house an electrode assembly, wherein
the container comprises a bottom wall and a plurality of side walls,
the bottom wall and the plurality of side walls are integrated to define an internal space therein for housing the electrode assembly and to further define a top opening on an opposing side from the bottom wall,
at least one of the bottom wall and the plurality of side walls comprises a liquid crystal aromatic poly(ester amide), and
the battery case has a water vapor transmission rate (WVTR) at a wall thickness of 1 millimeter of less than or equal to about 0.07 grams per square meter per day, as measured at 38° C. and a relative humidity of 100% according to ISO 15106 or ASTM F1249.

2. The battery case of claim 1, wherein the liquid crystal aromatic poly(ester amide) is a copolymerization product of liquid crystal monomers comprising at least one of an aromatic aminocarboxylic acid represented by Chemical Formula 1 and an aromatic aminophenol represented by Chemical Formula 2, and an aromatic hydroxycarboxylic acid represented by Chemical Formula 3:
NH₂—Ar¹—COOH Chemical Formula 1
wherein, in Chemical Formula 1, Ar¹ is a substituted or unsubstituted arylene-containing group, which is a single substituted or unsubstituted C6 to C30 arylene group, a fused ring of two or more substituted or unsubstituted C6 to C30 arylene groups, two or more substituted or unsubstituted C6 to C30 arylene groups linked by a single bond, —O—, —S—, —SO₂—, —C(═O)—, —CH₂ₙ—, —C(CₙH₂ₙ₊₁)— wherein n ranges from 1 to 10, or —NR— wherein R is hydrogen or a C1 to C5 alkyl group, or a combination thereof,
NH₂—Ar²—OH Chemical Formula 2
wherein, in Chemical Formula 2, Ar² is a substituted or unsubstituted arylene-containing group, which is a single substituted or unsubstituted C6 to C30 arylene group, a fused ring of two or more substituted or unsubstituted C6 to C30 arylene groups, two or more substituted or unsubstituted C6 to C30 arylene groups linked by a single bond, —O—, —S—, —SO₂—, —C(═O)—, —CH₂ₙ—, —C(CₙH₂ₙ₊₁)— wherein n ranges from 1 to 10, or —NR— wherein R is hydrogen or a C1 to C5 alkyl group, or a combination thereof, and
OH—Ar³—COOH Chemical Formula 3
wherein, in Chemical Formula 3, Ar³ is a substituted or unsubstituted arylene-containing group, which is a single substituted or unsubstituted C6 to C30 arylene group, a fused ring of two or more substituted or unsubstituted C6 to C30 arylene groups, two or more substituted or unsubstituted C6 to C30 arylene groups linked by a single bond, —O—, —S—, —SO₂—, —C(═O)—, —CH₂ₙ—, —C(CₙH₂ₙ₊₁)— wherein n ranges from 1 to 10, or —NR— wherein R is hydrogen or a C1 to C5 alkyl group, or a combination thereof.

3. The battery case of claim 2, wherein the liquid crystal aromatic poly(ester amide) is the copolymerization product of the liquid crystal monomers comprising the aromatic aminocarboxylic acid represented by Chemical Formula 1 and the aromatic hydroxycarboxylic acid represented by Chemical Formula 3.

4. The battery case of claim 3, wherein the aromatic aminocarboxylic acid represented by Chemical Formula 1 comprises 4-aminobenzoic acid, and the aromatic hydroxycarboxylic acid represented by Chemical Formula 3 comprises 4-hydroxybenzoic acid.

5. The battery case of claim 4, wherein the aromatic hydroxycarboxylic acid represented by Chemical Formula 3 further comprises at least one of glycolic acid, 6-hydroxy-2-naphthoic acid, 6-hydroxy-1-naphthoic acid, 3-methyl-4-hydroxybenzoic acid, 3,5-dimethyl-4-hydroxybenzoic acid, 2,6-dimethyl-4-hydroxybenzoic acid, 3-methoxy-4-hydroxybenzoic acid, 3,5-dimethoxy-4-hydroxybenzoic acid, 6-hydroxy-5-methyl-2-naphthoic acid, 6-hydroxy-5-methoxy-2-naphthoic acid, 2-chloro-4-hydroxybenzoic acid, 3-chloro-4-hydroxybenzoic acid, 2,3-dichloro-4-hydroxybenzoic acid, 3,5-dichloro-4-hydroxybenzoic acid, 2,5-dichloro-4-hydroxybenzoic acid, 3-bromo-4-hydroxybenzoic acid, 6-hydroxy-5-chloro-2-naphthoic acid, 6-hydroxy-7-chloro-2-naphthoic acid, 6-hydroxy-5,7-dichloro-2-naphthoic acid, p-β-hydroxyethoxybenzoic acid, or a combination thereof.

6. The battery case of claim 5, wherein the aromatic hydroxycarboxylic acid represented by Chemical Formula 3 further comprises 6-hydroxy-2-naphthoic acid.

7. The battery case of claim 3, wherein the liquid crystal monomers further comprise at least one of an aromatic dicarboxylic acid represented by Chemical Formula 4 and an aromatic diol represented by Chemical Formula 5:
COOH—Ar⁴—COOH Chemical Formula 4
wherein, in Chemical Formula 4, Ar⁴ is a substituted or unsubstituted arylene-containing group, which is a single substituted or unsubstituted C6 to C30 arylene group, a fused ring of two or more substituted or unsubstituted C6 to C30 arylene groups, or two or more substituted or unsubstituted C6 to C30 arylene groups linked by a single bond, —O—, —S—, —SO₂—, —C(═O)—, —CH₂ₙ—, —C(CₙH₂ₙ₊₁)— wherein n ranges from 1 to 10, or —NR— wherein R is hydrogen or a C1 to C5 alkyl group, or a combination thereof, and
OH—Ar⁵—OH Chemical Formula 5
wherein, in Chemical Formula 5, Ar⁵ is a substituted or unsubstituted arylene-containing group, which is a single substituted or unsubstituted C6 to C30 arylene group, a fused ring of two or more substituted or unsubstituted C6 to C30 arylene groups, or two or more substituted or unsubstituted C6 to C30 arylene groups linked by a single bond, —O—, —S—, —SO₂—, —C(═O)—, —CH₂ₙ—, —C(CₙH₂ₙ₊₁)— wherein n ranges from 1 to 10, or —NR— wherein R is hydrogen or a C1 to C5 alkyl group, or a combination thereof.

8. The battery case of claim 7, wherein the aromatic dicarboxylic acid represented by Chemical Formula 4 is at least one of terephthalic acid, 4,4′-biphenyldicarboxylic acid, 4,4′-terphenyldicarboxylic acid, 1,6-naphthalenedicarboxylic acid, 2,6-naphthalenedicarboxylic acid, 1,4-naphthalenedicarboxylic acid, 2,7-naphthalenedicarboxylic acid, diphenyl ether-4,4′-dicarboxylic acid, diphenoxyethane-4,4′-dicarboxylic acid, diphenoxy butane-4,4′-dicarboxylic acid, diphenylethane-4,4′-dicarboxylic acid, isophthalic acid, diphenylether-3,3′-dicarboxylic acid, diphenoxyethane-3,3′-dicarboxylic acid, diphenylethane-3,3′-dicarboxylic acid, chloroterephthalic acid, dichloroterephthalic acid, dichloroisophthalic acid, bromoterephthalic acid, methylterephthalic acid, dimethylterephthalic acid, ethylterephthalic acid, methoxyterephthalic acid, ethoxyterephthalic acid, or a combination thereof.

9. The battery case of claim 7, wherein the aromatic diol represented by Chemical Formula 5 is at least one of catechol, resorcinol, hydroquinone, 4,4′-dihydroxybiphenyl, 2,2-bis(4′-β-hydroxyethoxyphenyl)propane, bis(4-hydroxyphenyl) sulfone, bis(4-β-hydroxyethoxyphenyl) sulfonic acid, 9,9′-bis(4-hydroxyphenyl)fluorene, 3,3′-dihydroxybiphenyl, 4,4′-dihydroxyterphenyl, 2,6-naphthalenediol, 4,4′-dihydroxydiphenylether, bis(4-hydroxyphenoxy)ethane, 3,3′-dihydroxydiphenylether, 1,6-naphthalenediol, 2,2-bis(4-hydroxyphenyl)propane, bis(4-hydroxyphenyl)methane, chlorohydroquinone, methylhydroquinone, tert-butylhydroquinone, phenylhydroquinone, methoxyhydroquinone, phenoxyhydroquinone, 4-chlororesorcinol, 4-methylresorcinol, or a combination thereof.

10. The battery case of claim 2, wherein the liquid crystal aromatic poly(ester amide) is the copolymerization product of the liquid crystal monomers comprising the aromatic aminophenol represented by Chemical Formula 2 and the aromatic hydroxycarboxylic acid represented by Chemical Formula 3.

11. The battery case of claim 10, wherein the liquid crystal monomers further comprise an aromatic dicarboxylic acid represented by Chemical Formula 4:
COOH—Ar⁴—COOH Chemical Formula 4
wherein, in Chemical Formula 4, Ar⁴ is a substituted or unsubstituted arylene-containing group, which is a single substituted or unsubstituted C6 to C30 arylene group, a fused ring of two or more substituted or unsubstituted C6 to C30 arylene groups, or two or more substituted or unsubstituted C6 to C30 arylene groups linked by a single bond, —O—, —S—, —SO₂—, —C(═O)—, —CH₂ₙ—, —C(CₙH₂ₙ₊₁)— wherein n ranges from 1 to 10, or —NR— wherein R is hydrogen or a C1 to C5 alkyl group, or a combination thereof.

12. The battery case of claim 2, wherein at least one of the aromatic aminocarboxylic acid and the aromatic aminophenol is present in an amount of less than or equal to about 20 mole percent, based on the total mole numbers of the liquid crystal monomers of the liquid crystal aromatic poly(ester amide).

13. The battery case of claim 5, wherein the aromatic hydroxycarboxylic acid represented by Chemical Formula 3 comprises about 25 mole percent to about 75 mole percent of 4-hydroxybenzoic acid, and about 75 mole percent to about 25 mole percent of an aromatic hydroxycarboxylic acid different from the 4-hydroxybenzoic acid, based on the total mole numbers of the aromatic hydroxycarboxylic acid.

14. The battery case of claim 1, wherein the liquid crystal aromatic poly(ester amide) is a copolymerization product of about 5 mole percent to about 20 mole percent of 4-aminobenzoic acid, about 5 mole percent to about 70 mole percent of 4-hydroxybenzoic acid, and about 25 mole percent to about 80 mole percent of 6-hydroxy-2-naphthoic acid.

15. The battery case of claim 1, wherein the battery case has an impact strength as measured according to ASTM D265 of greater than or equal to about 10 kilogram-force per square centimeter.

16. The battery case of claim 1, wherein the battery case further comprises:
a lid configured to cover at least a portion of the top opening of the container; and
at least one of a positive terminal and a negative terminal.

17. The battery case of claim 16, wherein the lid comprises the liquid crystal aromatic poly(ester amide).

18. A battery comprising:
the battery case of claim 1, and
an electrode assembly comprising a positive electrode and a negative electrode,
wherein the electrode assembly is housed in the container of the battery case.

19. A liquid crystal polymer comprising a copolymer derived from about 5 mole percent to about 20 mole percent of 4-aminobenzoic acid, about 5 mole percent to about 70 mole percent of 4-hydroxybenzoic acid, and about 25 mole percent to about 80 mole percent of 6-hydroxy-2-naphthoic acid.

20. An article comprising the liquid crystal polymer of claim 19.

21. A method for the manufacture of a battery case comprising a liquid crystal aromatic poly(ester amide), the method comprising:
copolymerizing at least one of an aromatic aminocarboxylic acid and an aromatic aminophenol, and an aromatic hydroxycarboxylic acid to provide the liquid crystal aromatic poly(ester amide); and
molding the liquid crystal aromatic poly(ester amide) to provide the battery case.
